(19) United States
(12) Patent Application Publication
(10) Pub. No.: US 2009/0243877 A1
(43) Pub. Date: Oct. 1, 2009

(54) DUAL MODE MULTI-NETWORK AMR SYSTEM ENDPOINT AND RELATED SYSTEMS AND METHODS

(76) Inventor: Matthew Johnson, Spokane, WA (US)

Correspondence Address: DORITY & MANNING, P.A., POST OFFICE BOX 1449, GREENVILLE, SC, 29602-1449, US

(21) Appl. No.: 12/409,166

(22) Filed: Mar. 23, 2009

Related U.S. Application Data
(60) Provisional application No. 61/041,123, filed on Mar. 31, 2008.

(51) Int. Cl. G08C 15/06; H04B 7/00

(52) U.S. Cl. 340/870.02; 370/310

(57) ABSTRACT

Automatic meter reading system and devices providing for dual mode mesh network and non-mesh network endpoint communication. The system includes a plurality of endpoint devices communicatively coupled to at least one data collection device. At least one endpoint device is configurable to operate in a first mode or a second mode. At least one endpoint is adapted to independently determine whether to operate in the first mode or the second mode. In the first mode the endpoint operates according to a hub-and-spoke communication mode in which it communicates information intended for a data collection infrastructure device directly to at least one dedicated data collection infrastructure device. In the second mode the endpoint operates according to a mesh communications mode in which it communicates information intended for a data collection infrastructure device via a non-dedicated data collection infrastructure device. At least some of the endpoint devices are capable of switching between a mesh-network mode and a non-mesh network mode.

### RELATED APPLICATION

This Application claims the benefit of U.S. Provisional Application No. 61/041,123, entitled “DUAL MODE MULTI-NETWORK AMR SYSTEM ENDPOINT AND RELATED SYSTEMS AND METHODS,” filed on Mar. 31, 2008, which is incorporated by reference herein in its entirety.

### FIELD OF THE INVENTION

The invention relates generally to radio frequency (RF) communication systems, and more particularly to RF communication architectures, systems, and methods used in fixed or mobile network advanced automatic meter reading (AMR) systems.

### BACKGROUND OF THE INVENTION

Automatic meter reading (AMR) systems are generally known in the art. Utility companies, for example, use AMR systems to read and monitor customer meters remotely, typically using radio frequency (RF) and other wireless communications. AMR systems are favored by utility companies and others who use them because they increase the efficiency and accuracy of collecting readings and managing customer billing. For example, utilizing an AMR system for the monthly reading of residential gas, electric, or water meters eliminates the need for a utility employee to physically enter each residence or business where a meter is located to transcribe a meter reading by hand.

Typical AMR systems include at least one head-end controller that manages the AMR system. The head-end controller is communicatively coupled to at least one collection device. Collection devices may be fixed or mobile collection devices. Typical AMR systems also include a plurality of endpoints, which are devices adapted to communicate with collection devices to communicate data and/or commands. An endpoint device is typically affixed to a utility meter or communicatively coupled to the meter. An endpoint device may also be part of the meter itself.

Various methods of communication with endpoints in AMR systems exist. These methods may include one-way, one-and-a-half-way, or two-way communications capabilities. For one-way communications, an endpoint device is adapted to periodically turn on, or “bubble up,” and send data to a collection device without any prompting by the system. For one-and-a-half-way communications the endpoint device listens for a wake-up signal, and data is transmitted in response to the wake-up signal. For two-way communication, endpoints are adapted to receive and transmit command and control data as well as other data. Two-way AMR systems generally provide greater reliability and customizability, however they consume more power, which is a significant concern in battery powered endpoints. One-way and one-and-a-half way communications do not provide the same levels of reliability and customizability as two-way communications, however they consume less power than two-way systems.

In addition to the various methods of communication, an AMR network may be configured as a hub-and-spoke network or a mesh network. A hub-and-spoke network is one in which an endpoint directly communicates a head-end controller, a collection device, or a repeater in order to communicate with the same or a different head-end controller, a collection device, or a repeater. In one example of an endpoint communicating in a hub-and-spoke network mode, an endpoint communicates information intended for a collector device by communicating directly with the collector device. In another example of an endpoint communicating in a hub-and-spoke network mode, an endpoint communicates information intended for a collector device by communicating via a repeater. A repeater is adapted to extend the available coverage area of a hub-and-spoke AMR network by receiving and re-transmitting a signal originating from another data collection infrastructure device intended for an endpoint, or by receiving and re-transmitting a signal originating from an endpoint intended for receipt by another data collection infrastructure device.

A mesh network is one in which an endpoint is adapted to communicate with a head-end controller, a collection device, or a repeater via at least one other endpoint. In one example, an endpoint communicating over a mesh network is adapted to communicate information intended for a collector via another endpoint. Data or commands originating from a data collection infrastructure device intended for an endpoint may pass through multiple other endpoints before it reaches the endpoint. Similarly, data or commands originating from an endpoint intended for a data collection infrastructure device may pass through multiple other endpoints before it reaches the data collection infrastructure device.

As addressed above, two-way communication is generally disadvantageous in that it requires relatively large amounts of power to transmit and receive data. This is partially due to the need to communicate over large distances. Communication over large distances is disadvantageous when using a hub-and-spoke network, because of the need for either higher transmission power or for additional dedicated data collection infrastructure device(s) (such as repeaters or additional collector devices). Either approach is costly to implement, the former may require special licensing and would consume greater amounts of energy, thereby shortening battery life. The latter complicates the AMR system operations.

A mesh network is advantageous in that it allows two-way communications while utilizing less power than a hub-and-spoke network using two-way communications. When operating in a mesh network configuration, endpoints are able to communicate over large distances without additional data collection infrastructure devices because they communicate with other endpoints over shorter distances. Thus, higher transmission power and additional dedicated data collection infrastructure device(s) are not necessary.

Although mesh networks provide certain advantages over hub-and-spoke networks, it is often difficult to change an existing hub-and-spoke network into a mesh network. Existing AMR devices must be modified and/or replaced, resulting in high costs. Often, modifying an AMR network results in network shutdowns or other issues. Therefore, a need exists to provide an improved system and method for updating an existing hub-and-spoke AMR network to a mesh AMR network.

While mesh networks provide advantages for two-way communications, hub-and-spoke networks may also provide advantages when utilizing one-way or one-and-a-half-way communications. Therefore, a need also exists to provide an improved system and method for operating some endpoints using hub-and-spoke network configurations, while operating other endpoints in a mesh network configuration. A further need exists to operate endpoints using hub-and-spoke or mesh network configurations during certain time periods, or during certain operations.

### SUMMARY OF INVENTION

Aspects of the invention seek to address the aforementioned challenges and also allow utilities and other users to buy and deploy endpoint devices that operate with enhanced functionality and flexibility. Aspects of the invention also seek provide an AMR system with a communication architecture that would allow utilities to switch between mesh network and hub-and-spoke network communication as needed.

In one aspect of the invention, systems and devices providing for dual mode mesh network and non-mesh network endpoint communication are provided. The system includes at least one head-end controller. The system includes at least one data collection device communicatively coupled to the head-end controller. The system includes a plurality of endpoint devices communicatively coupled to the at least one data collection device, and at least one endpoint device of the plurality of endpoint devices is configurable to operate in a first mode or a second mode. The system includes at least one endpoint of the plurality of endpoints is adapted to independently determine whether to operate in the first mode or the second mode. In the first mode the endpoint operates according to a hub-and-spoke communication mode in which it communicates information intended for a data collection infrastructure device directly to at least one dedicated data collection infrastructure device. In the second mode the endpoint operates according to a mesh communications mode in which it communicates information intended for a data collection infrastructure device via a non-dedicated data collection infrastructure device.

In another aspect of the invention, a method of operating an endpoint device is provided. The method includes operating the endpoint in a non-mesh network mode, in which the endpoint is adapted to communicate information intended for a data collection infrastructure device directly to at least one dedicated data collection infrastructure device. The method includes periodically operating the endpoint to listen for a mesh network. The method includes detecting, by the endpoint device, a presence of the mesh network. The method includes operating the endpoint device to determine whether the endpoint is admitted to the mesh network. The method includes initializing the endpoint to join the mesh network. The method includes operating the endpoint device to communicate in a mesh network, in which the endpoint is adapted to communicate information intended for a data collection infrastructure device via a non-dedicated data collection infrastructure device.

### BRIEF DESCRIPTION OF THE DRAWINGS

FIG. 1 illustrates generally a hub-and-spoke AMR network.

FIG. 2 illustrates generally a mesh AMR network.

FIG. 3 illustrates generally one embodiment of a dual mode mesh and hub-and-spoke AMR network according to one aspect of the invention.

FIG. 4 illustrates generally one embodiment of a dual mode mesh and hub-and-spoke AMR network according to one aspect of the invention.

FIG. 5 illustrates generally a flowchart of an embodiment of a method of operating an endpoint device adapted to independently detect a mesh network and determine a mode of operation according to one aspect of the invention.

FIG. 6 illustrates generally a flowchart of an embodiment of a method of operating a dual mode AMR network according to one aspect of the invention.

FIG. 7 illustrates generally a flowchart of an embodiment of a method of operating an endpoint device to independently detect a mesh network and determine a mode of operation according to one aspect of the invention.

FIG. 8 illustrates generally a block diagram of a system architecture according to one aspect of the invention.

While the invention is amenable to various modifications and alternative forms, specific examples shown in the drawings will be described in detail. It should be understood, however, that the intention is not to limit the invention to the particular embodiments described. On the contrary, the intention is to cover all modifications, equivalents, and alternatives falling within the spirit and scope of the invention as defined by the appended claims.

### DETAILED DESCRIPTION OF THE PREFERRED EMBODIMENTS

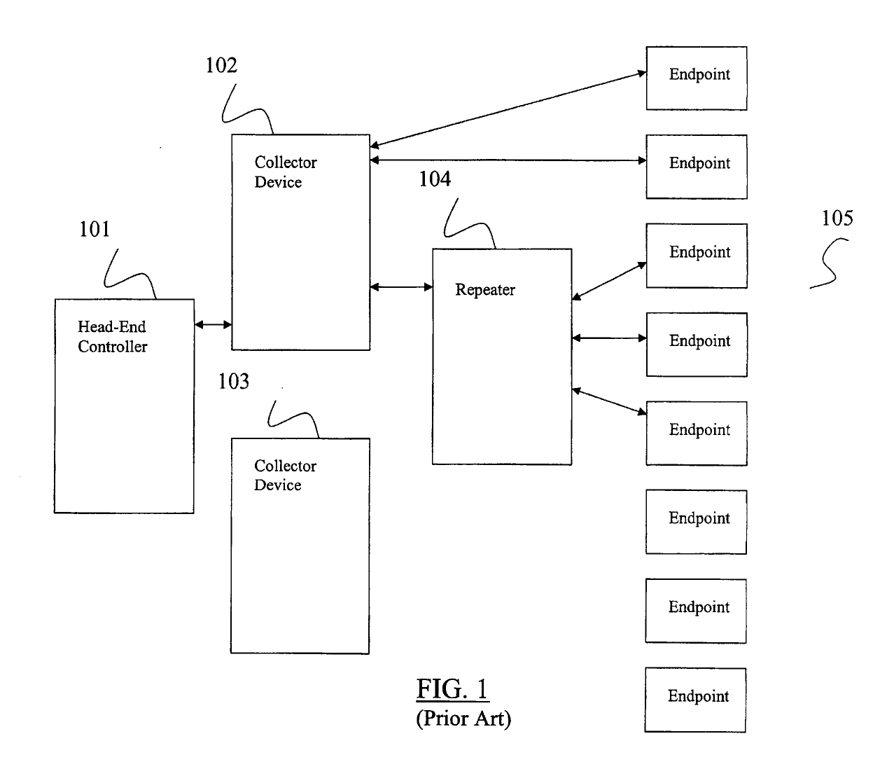

The invention can be more readily understood by referring to FIGS. 1-8 and the following description. While the present invention is not necessarily limited to the embodiments discussed below, the invention will be better appreciated using a discussion of an example embodiment in such a specific context.

FIG. 1 illustrates generally an example of a hub-and-spoke network. The network includes dedicated data collection infrastructure devices: head-end controller 101, collector devices 102 103, and repeater 104. Head-end controller 101 is the central “hub” of the network. Head-end controller 101 is adapted to receive, store, and transmit data and commands from other AMR devices. Typically, head-end controller 101 is adapted to receive, transmit, and store data and commands from collector devices 102 103. Collector devices 102 103 are also adapted to receive, store, and transmit data and information. Collector devices 102 103 are typically adapted to collect information and communicate the information to head-end controller 101.

The hub-and-spoke network also includes repeater 104. Repeater 104 is another dedicated data collection infrastructure device that is adapted to extend the coverage area of the hub-and-spoke network by receiving and re-transmitting signals.

The hub-and-spoke network also includes endpoints 105. Endpoints 105 are coupled with utility meters. Endpoints 105 are adapted as an interface such that data and commands can be communicated to and from utility meters. According to the hub-and-spoke network illustrated in FIG. 1, endpoints 105 are adapted to communicate data or commands intended for at least one of dedicated data collection infrastructure devices 101-104 directly with at least one of dedicated data collection infrastructure devices 101-104.

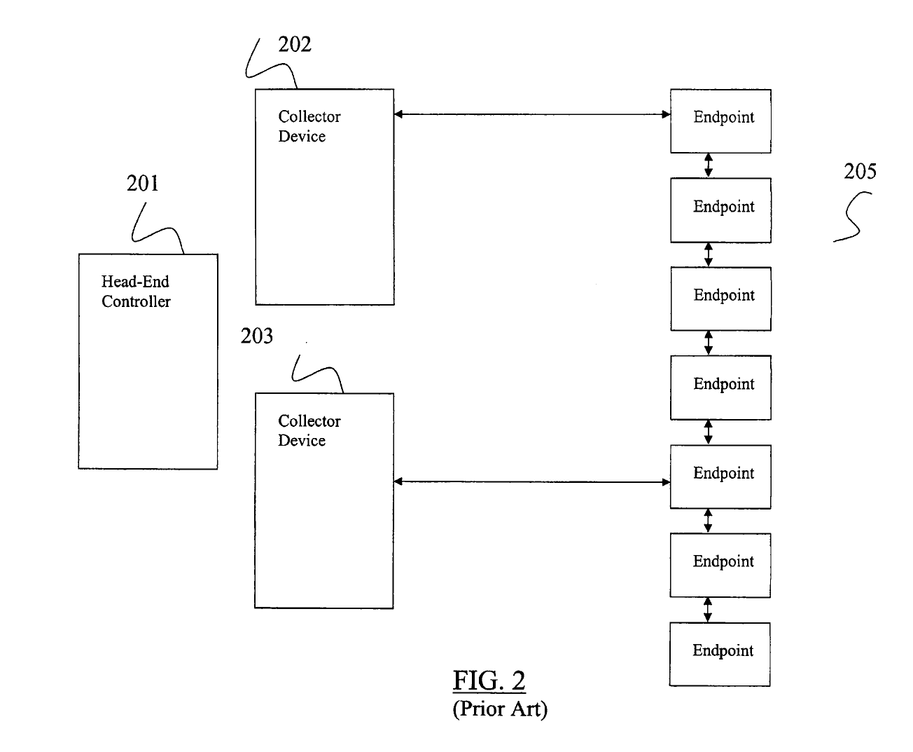

FIG. 2 illustrates generally an example of a mesh network. Similar to the example illustrated in FIG. 1, the example of FIG. 2 includes dedicated data collection infrastructure devices 201-203 and endpoints 205. Unlike the example of FIG. 1, in addition to being adapted to communicate data or commands intended for at least one of data collection infrastructure devices 201-203 endpoints 205 (non-dedicated data collection infrastructure devices), are adapted to communicate data or commands intended for at least one of data collection infrastructure devices 201-203 via communicating with at least one other endpoint of endpoints 205.

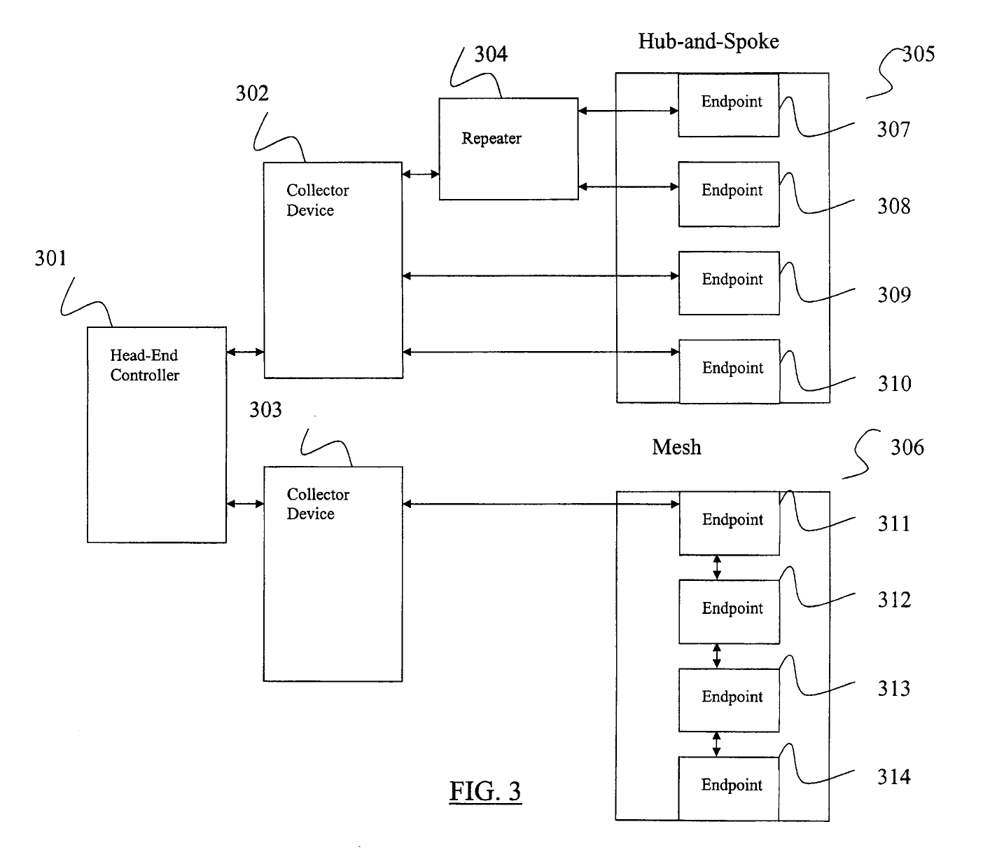

FIG. 3 illustrates generally one embodiment of an AMR network according to the subject matter disclosed herein. According to this embodiment, AMR network includes dedicated data collection infrastructure devices: head-end controller 301, collector devices 302 303, and repeater 304. The AMR network further includes endpoints 307-314. According to this embodiment, endpoints 307-310 are configured to communicate in a hub-and-spoke mode 305. Also according to this embodiment, endpoints 311-314 are configured to operate in a mesh network mode 306. In one embodiment, endpoints 307-314 are dual mode endpoints. According to this embodiment, endpoints 307-314 are configurable to operate in either a hub-and-spoke mode 305 or a mesh network mode 306. In one embodiment, endpoints 307-314 are adapted to independently determine whether to operate in a hub-and-spoke mode 305 or mesh network mode 306. In one embodiment, endpoints 307-310 are not dual mode endpoints, while endpoints 311-314 are dual mode endpoints. According to this embodiment, endpoints 311-314 are configurable to operate in either a hub-and-spoke mode 305 or a mesh network mode 306.

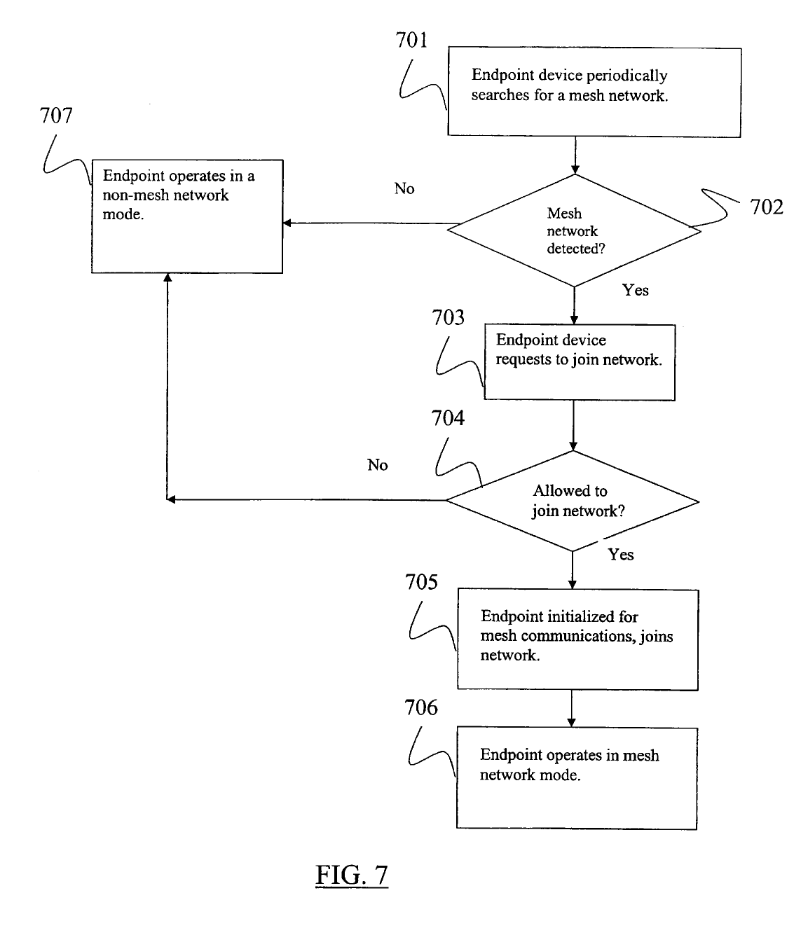

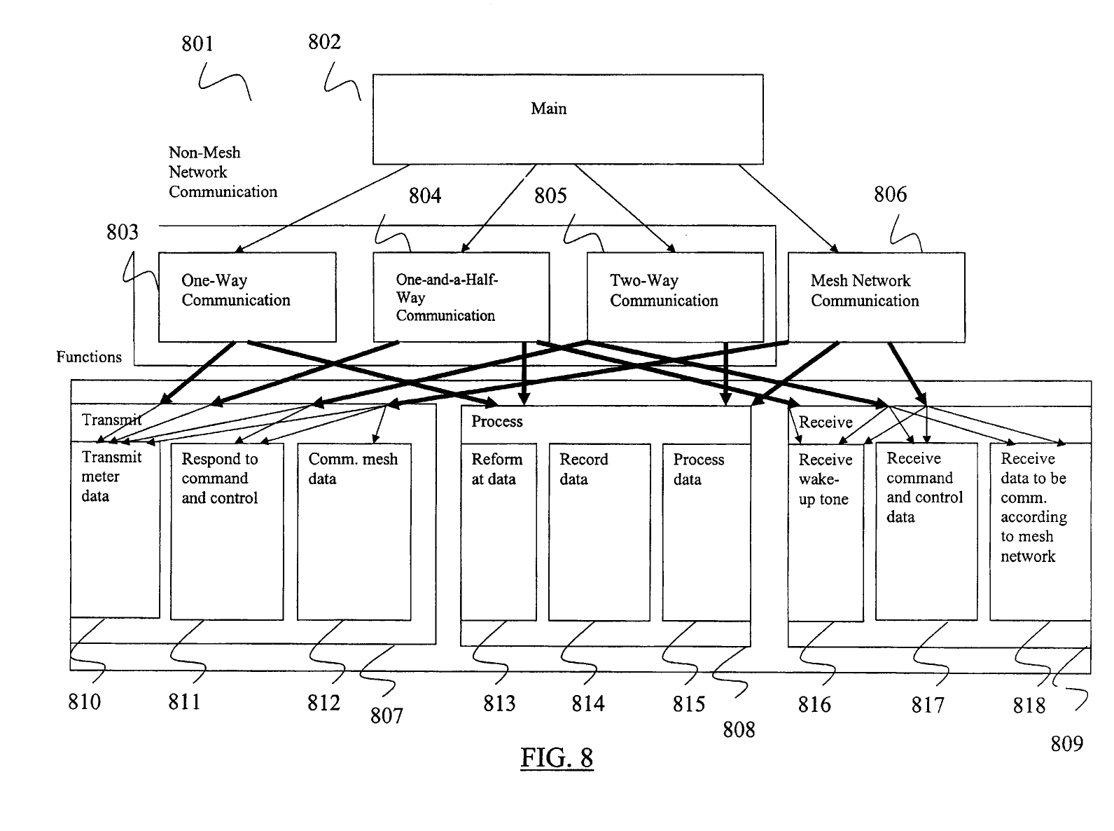

In various embodiments, endpoints 307-310 are adapted to communicate data or commands intended for or originating from dedicated data collection infrastructure devices 301-304 by communicating directly with at least one of dedicated data collection infrastructure devices 301-304 as discussed with respect to FIG. 7 above. In various embodiments, endpoints 311-314 are adapted to communicate data or commands intended for or originating from dedicated data collection infrastructure devices 301-304 via communicating with non-dedicated data collection infrastructure devices (other endpoints), as discussed with respect to FIG. 8 above. In the embodiment illustrated in FIG. 3, endpoints 311-314 are adapted to communicate data or commands intended for or originating from dedicated data collection infrastructure devices 301-304 by communicating via endpoint 311 either directly or via other endpoints.

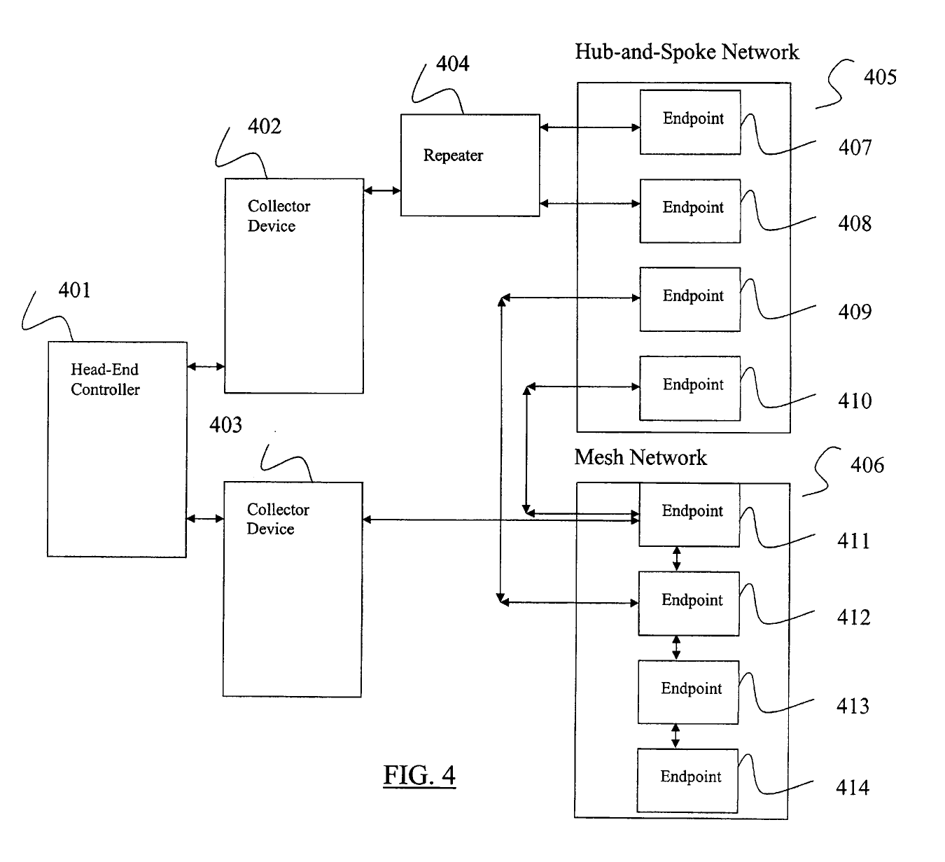

FIG. 4 illustrates generally one embodiment of an AMR network according to the subject matter disclosed herein. The embodiment illustrated in FIG. 4 is similar to the embodiment of FIG. 3, except endpoints 409 and 410 are initially operating in a hub-and-spoke mode. Endpoints 409 and 410 are dual mode endpoints. In one embodiment, during operation, endpoints 409 and 410 receive a command from at least one of dedicated data collection infrastructure devices 401-404 instructing the endpoints 409 and 410 to join mesh network 406. In another embodiment, endpoints 409 and 410 independently detect and join mesh network 406. According to the embodiment illustrated in FIG. 4, once endpoints 411 and 412 have joined mesh network 406, endpoint 409 is adapted to communicate with endpoint 412, endpoint 412 is adapted to communicate with endpoint 411, and endpoint 411 is adapted to communicate with collector device 403. Likewise, endpoint 410 is adapted to communicate with collector 403 via endpoint 411.

The embodiments illustrated in FIG. 3 and FIG. 4 are advantageous because they allow endpoints operating in both mesh network and hub-and-spoke network modes to communicate in the same network. Furthermore, because at least some of the endpoints are configurable between a mesh network and a hub-and-spoke network mode, greater flexibility exists in both system operation and conversion from a hub-and-spoke network to a mesh network.

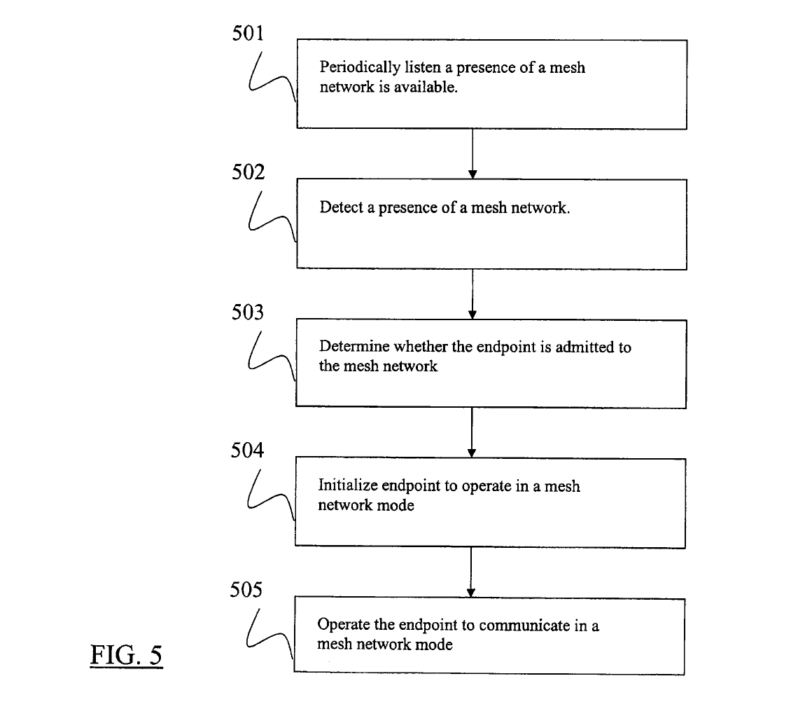

FIG. 5 illustrates generally one embodiment of operating a dual mode endpoint according to the subject matter disclosed herein. According to this embodiment, the endpoint is adapted to independently determine whether to operate in a mesh-network or a hub-and-spoke network mode. In various embodiments, the endpoint is operating in a non-mesh network mode. At 501, the endpoint periodically listens for the presence of a mesh network. At 502 a presence of a mesh network is detected by the endpoint. At 503, the endpoint is operated to determine whether it is admitted to the mesh network. In one embodiment, determining whether the endpoint is admitted includes listening for an indication that the endpoint is admitted. In another embodiment, determining whether the endpoint is admitted includes communicating with at least one of dedicated data collection infrastructure devices 301-304. In another embodiment, determining whether the endpoint is admitted includes receiving a command from at least one of dedicated data collection infrastructure devices 301-304. If the endpoint determines it is admitted, at 504 the endpoint is initialized to operate in a mesh network mode. In one embodiment, the endpoint initializes itself to operate in a mesh network mode. In another embodiment, at least one of dedicated data collection infrastructure devices 301-304 initializes the endpoint to operate in a mesh network mode. At 505, the endpoint is operated to communicate in a mesh network mode.

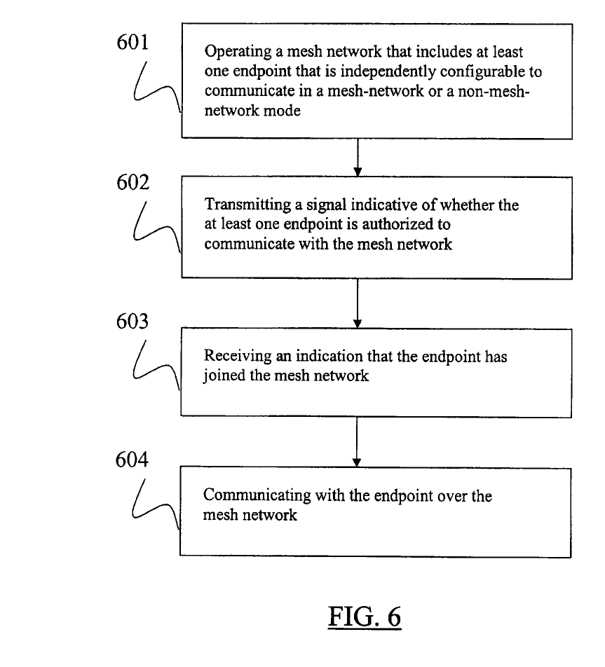

FIG. 6 illustrates generally one embodiment of operating a mesh network including at least one dual mode endpoint according to the subject matter disclosed herein. At 601, a mesh network is operated that includes at least one endpoint that is independently configurable to communicate in mesh network or a non-mesh-network mode. At 602, a dedicated data collection infrastructure device 301-304 transmits an indication whether a particular endpoint or group of endpoints are authorized to communicate with the mesh network. In one embodiment, the indication is sent in response to a prompt initiated by an endpoint. In another embodiment, the indication is constantly or periodically transmitted. In one embodiment, the indication is a command. In another embodiment, the indication is an indication of authorization. At 603, a data collection infrastructure device receives an indication that the endpoint has determined that it is authorized and has joined the mesh network. At 604, the dedicated data collection infrastructure device operates to communicate with the endpoint over the mesh network.

FIG. 7 illustrates generally one embodiment of operating a dual mode endpoint according to the subject matter disclosed herein. According to this embodiment, the endpoint is adapted to independently determine whether to operate in a mesh-network or a non-mesh network mode. At 701, the endpoint periodically searches for a mesh network. At 702, if a presence of a mesh network is not detected by the endpoint, at 707 the endpoint operates in a non-mesh network mode. If at 702, a presence of a mesh network is detected, at 703 the endpoint requests permission to join the network. At 704, if the endpoint is not granted permission to join the network, at 707 the endpoint operates in a non-mesh network mode. If at 704 the endpoint is granted permission to join the mesh network, at 705 the endpoint is initialized for mesh communications, and the endpoint joins the mesh network. At 706, the endpoint operates in a mesh network mode.

FIG. 8 depicts a block diagram of one embodiment of a system architecture 801 according to one aspect of the invention. In various embodiments, at least some of the functionalities and/or resources needed to implement mesh network and non-mesh network AMR communication are shared.

In various embodiments, main function 802 controls the overall functionality of system architecture 801. In one embodiment, main function 802 determines what mode of communication in which to operate endpoint device 105. In one embodiment, main function 802 may determine that endpoint 105 should operate in a non-mesh network communication mode. A non-mesh network communication mode may include: one-way mode 803, one-and-a-half way mode 804, or two-way mode 805. In one embodiment, main function may determine that endpoint should operate in a mesh network mode 806.

In various embodiments, system architecture 801 is adapted such that functionalities between available modes of communication for endpoint device 108 may be used for more than one mode of communication. In an embodiment, the functionalities described herein are implemented through software subroutines. According to this embodiment, the subroutines are called by main function 802.

According to the embodiments illustrated in FIG. 8, the different modes of communication discussed above all use functionalities such as receive functionality 809, processing functionality 808, or transmit functionality 807.

In one embodiment, when an endpoint is operated in a one-way communication mode 803, endpoint may utilize transmit functionalities 807, including transmit meter data functionalities 810. In one embodiment, when an endpoint is operated in a one-way communication mode 803, endpoint may utilize processing functionalities 808, including data reformatting functionalities 813, data recording functionalities 814, and other data processing functionalities 815.

In one embodiment, when an endpoint is operated in a one-and-a-half-way communication mode 804, endpoint may utilize transmit functionalities 807, including transmit meter data functionalities 810. In one embodiment, when an endpoint is operated in a one-and-a-half-way communication mode 804, that endpoint may utilize processing functionalities 808, including data reformatting functionalities 803, data recording functionalities 814, and other data processing functionalities 815. In one embodiment, when an endpoint is operated in a one-and-a-half-way communication mode 804, that endpoint may utilize receiving functionalities 809, including receiving a wake-up tone 816.

In one embodiment, when an endpoint is operated in a two-way communication mode 805, endpoint may utilize transmit functionalities 807, including transmit meter data functionalities 810, and transmit command and control response functionalities 811. In one embodiment, when an endpoint is operated in a two-way communication mode 805, that endpoint may utilize processing functionalities 808, including data reformatting functionalities 813, data recording functionalities 814, and other data processing functionalities 815. In one embodiment, when an endpoint is operated in a two-way communication mode 805, endpoint may utilize receiving functionality 809, including receiving a wake-up tone 816, and receiving command and control data 817.

In one embodiment, when an endpoint is operated in a mesh network communication mode 806, endpoint may utilize transmit functionalities 807, including transmit meter data functionalities 810, transmit command and control response functionalities 811, and transmit mesh data functionalities 812. In one embodiment, when an endpoint is operated in a mesh network communication mode 806, that endpoint may utilize processing functionalities 808, including data reformatting functionalities 813, data recording functionalities 814, and other data processing functionalities 815. In one embodiment, when an endpoint is operated in a mesh network communication mode 806, endpoint may utilize receiving functionalities 809, including receiving a wake-up tone 816, receiving command and control data 817, and receiving data to be communicated according to mesh network 818.

The embodiments above are intended to be illustrative and not limiting. Additional embodiments are within the claims. In addition, although aspects of the present invention have been described with reference to particular embodiments, those skilled in the art will recognize that changes can be made in form and detail without departing from the spirit and scope of the invention, as defined by the claims.

Persons of ordinary skill in the relevant arts will recognize that the invention may comprise fewer features than illustrated in any individual embodiment described above. The embodiments described herein are not meant to be an exhaustive presentation of the ways in which the various features of the invention may be combined. Accordingly, the embodiments are not mutually exclusive combinations of features; rather, the invention may comprise a combination of different individual features selected from different individual embodiments, as understood by persons of ordinary skill in the art.

Any incorporation by reference of documents above is limited such that no subject matter is incorporated that is contrary to the explicit disclosure herein. Any incorporation by reference of documents above is further limited such that no claims included in the documents are incorporated by reference herein. Any incorporation by reference of documents above is yet further limited such that any definitions provided in the documents are not incorporated by reference herein unless expressly included herein.

For purposes of interpreting the claims for the present invention, it is expressly intended that the provisions of Section 112, sixth paragraph of 35 U.S.C. are not to be invoked unless the specific terms “means for” or “step for” are recited in a claim.

We claim:

1. An automatic meter reading system comprising:
at least one head-end network controller;
at least one data collection device communicatively coupled to the head-end controller;
a plurality of endpoint devices communicatively coupled to the at least one data collection device, wherein at least one endpoint device of the plurality of endpoint devices is configurable to operate in a first mode or a second mode;
wherein at least one endpoint device of the plurality of endpoint devices is adapted to independently determine whether to operate in the first mode or the second mode;
wherein in the first mode the at least one endpoint device operates according to a hub-and-spoke communication mode in which the at least one endpoint device communicates information intended for a data collection infrastructure device directly to at least one dedicated data collection infrastructure device, and the at least one endpoint device does not receive any information from a non-dedicated data collection infrastructure device; and
wherein in the second mode the at least one endpoint device operates according to a mesh communications mode in which the at least one endpoint device communicates information intended for a data collection infrastructure device via a non-dedicated data collection infrastructure device.

2. The system of claim 1, wherein at least one endpoint device of the plurality of endpoint devices is adapted to periodically listen to detect whether a network exists with which the at least one endpoint device can communicate in the second mode, and wherein the at least one endpoint device is adapted to:
detect the network;
determine whether it is admitted to the network;
initialize to operate with the network; and
communicate with the network.

3. The system of claim 2, wherein the at least one endpoint device is adapted to determine whether it is admitted to the network by receiving an indication of authorization from the network that the at least one endpoint device may join the network.

4. The system of claim 2, wherein the at least one endpoint device is adapted to determine whether it is admitted to the network by receiving a command to join the network.

5. The system of claim 1, wherein if the at least one endpoint device is not able to operate in the second mode, the at least one endpoint device automatically reverts to operating in the first mode.

6. The system of claim 1, wherein in the first mode the at least one endpoint device is adapted to periodically transmit data on a one-way bubble up basis.

7. The system of claim 1, wherein in the first mode the at least one endpoint device is adapted to transmit data in response to a prompt by the dedicated data collection infrastructure device.

8. The system of claim 1, wherein in the first mode the at least one endpoint device is adapted to receive command and control data from the dedicated data collection infrastructure device.

9. The system of claim 1, wherein the non-dedicated data collection infrastructure device is another endpoint device operating in the second mode.

10. An improved endpoint device including communications circuitry and controller circuitry configured with program instructions that enable the endpoint device to communicate in an automatic meter reading (AMR) system utilizing the communications circuitry, the improvement comprising:
the controller circuitry being self-configurable to cause the endpoint device to communicate in a first mode or a second mode;
wherein when configured in the first mode the endpoint device is adapted to operate according to a hub-and-spoke communication mode in which the endpoint device communicates information intended for a data collection infrastructure device directly to at least one dedicated data collection infrastructure device and the endpoint device does not receive any information from a non-dedicated data collection infrastructure device;
wherein when configured in the second mode the endpoint device is adapted to operate according to a mesh network communication mode in which the endpoint device communicates information intended for a data collection infrastructure device via a non-dedicated data collection infrastructure device; and
wherein the controller circuitry is adapted to independently determine whether to self-configure in the first mode or the second mode.

11. The endpoint device of claim 10, wherein the endpoint device is adapted to periodically listen to detect whether a network exists that is adapted to communicate with the endpoint device according to the second mode;
wherein the endpoint device is adapted to detect the network;
wherein the endpoint device is adapted to determine whether it is admitted to the network;
wherein the endpoint device is adapted to initialize to operate with the network; and
wherein the endpoint device is adapted to communicate with the network.

12. The endpoint device of claim 11, wherein the endpoint device is adapted to determine whether it is admitted to the network by receiving an indication of authorization from the network that the endpoint device may join the network.

13. The endpoint device of claim 11, wherein the endpoint device is adapted to determine whether it is admitted to the network by receiving a command to join the network.

14. The endpoint device of claim 10, wherein if the endpoint device is not operated in the second mode, the endpoint device automatically reverts to operating in the first mode.

15. The endpoint device of claim 10, wherein the non-dedicated data collection infrastructure device is another endpoint device operating in the second mode.

16. A method of operating an endpoint device, comprising:
operating the endpoint device in a non-mesh network mode, in which the endpoint device is adapted to communicate information intended for a data collection infrastructure device directly to at least one dedicated data collection infrastructure device and the endpoint device does not receive any information from a non-dedicated data collection infrastructure device;
periodically operating the endpoint device to listen for a mesh network;
detecting, by the endpoint device, a presence of the mesh network;
operating the endpoint device to determine whether the endpoint device is admitted to the mesh network;
initializing the endpoint device to join the mesh network; and
operating the endpoint device to communicate in a mesh network mode, in which the endpoint device is adapted to communicate information intended for a data collection infrastructure device via a non-dedicated data collection infrastructure device.

17. The method of claim 16, wherein when the endpoint device is not able to operate in a mesh network mode, automatically operating the endpoint device in the non-mesh network mode.

18. The method of claim 16, wherein when the endpoint device is operating in the non-mesh network mode, operating the endpoint device to transmit data in response to a prompt by the dedicated data collection infrastructure device.

19. The method of claim 16, comprising:
when the endpoint device is operating in the non-mesh network mode, operating the endpoint device to periodically transmit data on a one-way bubble-up basis.

20. The method of claim 16, wherein communicating information intended for a data collection infrastructure device via a non-dedicated data collection infrastructure device includes communicating via another endpoint device operating in the mesh network mode.
